(19) United States
(12) Patent Application Publication
(10) Pub. No.: US 2011/0157190 A1
(43) Pub. Date: Jun. 30, 2011

(54) FAST INTEGER DCT METHOD ON MULTI-CORE PROCESSOR

(76) Inventors: Tsung-Han TSAI, Zhongli City (TW); Huang-Chun Lin, Keelung City (TW); Yu-Hsuan Lee, Yonghe City (TW)

(21) Appl. No.: 12/711,843

(22) Filed: Feb. 24, 2010

(30) Foreign Application Priority Data
Dec. 24, 2009 (TW) 098144700

(51) Int. Cl. G06F 15/16; H04N 7/26

(52) U.S. Cl. 345/502; 375/E07.2

(57) ABSTRACT

In a fast integer DCT method on multi-core processor, the instructions executed by a DSP are allocated with regular and symmetrical data flows for improving the hardware utilization of each task engine of a digital signal processor. Thus, common terms exhibit symmetrical arithmetical instructions. The symmetrical arithmetical instructions are properly arranged for task engines in parallel processing. The loading of the digital signal processor can be effectively reduced in performing the integer discrete cosine transformation to accordingly generate the result quickly.

### BACKGROUND OF THE INVENTION

1. Field of the Invention

The present invention relates to the technical field of video coding and decoding and, more particularly, to a fast integer discrete cosine transformation (DCT) method on multi-core processor.

2. Description of Related Art

With tending to high compression rate and high resolution required for multimedia image compression techniques, real-time coding/decoding is requested, and a faster coding and decoding module is widely required. In a multimedia system, an integer discrete transformation is a key tool of compression and widely used in multimedia systems such as H.264/AVC, H.264/SVC, H.264/MVC, AVS, and the like.

Currently, popular video coding/decoding systems, such as H.264/AVC, H.264/SVC, MPEG4, typically use an integer DCT 130 to remove additional image information to thereby concentrate the information on low frequency and generate compressed video information. FIG. 1 is a schematic diagram of a typical configuration of coding/decoding system. As shown in FIG. 1, the integer DCT 130 follows a motion estimator 110 and a motion compensator 120. At the coder side, it uses a decoded previous picture or frame Fn−1′ as a reference of compressed film. Accordingly, a coded current frame Fn is decoded and converted by an inverse integer DCT 140 into a reconstruction frame Fn′. Thus, a coder needs to execute numerous discrete cosine transformations. In a high resolution video compression, the DCT operation is relatively increased. For example, a CIF video requires the DCT operation four times than a QCIF video. In an H.264/SVC system, it requires more DCT operations for QCIF and CIF videos.

In addition to using a typical ASIC to implement the integer DCT in multimedia applications, an embedded system processor or a multi-core processor can be used.

For the audiovisual platforms using an embedded system processor or a multi-core processor, many people currently use the VIDEO/IMAGE Processing Library developed by Texas Instruments to speed up the development of DCT algorithm. The VIDEO/IMAGE Processing Library has good performance and convenient application, but it supports only an 8×8 block DCT, which has some difference from the defined specification of current video compression. In addition, such a processing library is only suitable for TI-based DSPs, not for marketing multi-core processors.

Further, many researchers propose the Single Instruction Multiple Data (SIMD) approach for gaining an optimization of 4×4 block DCT. The SIMD approach uses a series of multi-add instructions to simplify the operation. However, doing multiplication occupies much CPU time in applications, which may increase the performance but neglect the utility of CPU hardware unit.

Therefore, there still are problems existed in the conventional integer DCT operation, and thus it is desirable to provide an improved method to mitigate and/or obviate the aforementioned problems.

### SUMMARY OF THE INVENTION

The object of the present invention is to provide a fast integer discrete cosine transformation (DCT) method on multi-core processor, which can reduce the processor loading on a DCT operation and complete the operation in a short cycle.

According to a feature of the invention, a fast integer discrete cosine transformation (DCT) method on multi-core processor is provided, which is used in a video compression and decompression system for performing an integer DCT operation on pixels of an image. The system has a memory and a digital signal processor (DSP) with a register file and two task engines. The method includes: (A) reading pixel data from the memory to the register file; (B) according to an integer DCT equation to allocate operation ranges of each task engine, which is based on the number of task engines of the DSP to divide its operation flow into two to accordingly allocate the operation ranges of each task engine; (C) preprocessing the pixel data of registers of the register file to thereby generate different weighted pixel data; (D) calculating common terms of the different weighted pixel data, which is based on a feature of a transport matrix of integer DCT coefficients to calculate the common terms; (E) according to the common terms to calculate first temporary terms; (F) calculating second temporary terms by repeating steps (C) to (E); and (G) completing the DCT operation by repeating steps (C) to (F), wherein a feature of the integer DCT coefficients is used to calculate the common terms.

Other objects, advantages, and novel features of the invention will become more apparent from the following detailed description when taken in conjunction with the accompanying drawings.

### BRIEF DESCRIPTION OF THE DRAWINGS

FIG. 1 is a schematic diagram of a typical configuration of coding/decoding system;

FIG. 2 is a block diagram of a partial video compression and decompression system according to the invention;

FIG. 3 is a flowchart of a fast integer discrete cosine transformation method on multi-core processor according to the invention;

FIG. 4 is a schematic diagram of an operation of DCT matrix according to the invention;

FIG. 5 is a schematic diagram of LDDW instructions for writing data in registers according to the invention;

FIG. 6 is a schematic diagram of a rearranged DCT equation according to the invention;

FIG. 7 is a schematic diagram of preprocessing pixel data of registers according to the invention;

FIG. 8 is a schematic diagram of calculating common terms according to the invention;

FIG. 9 is a schematic diagram of calculating temporary terms according to the invention; and

FIG. 10 is a schematic diagram of an instruction allocation when task engines work according to the invention.

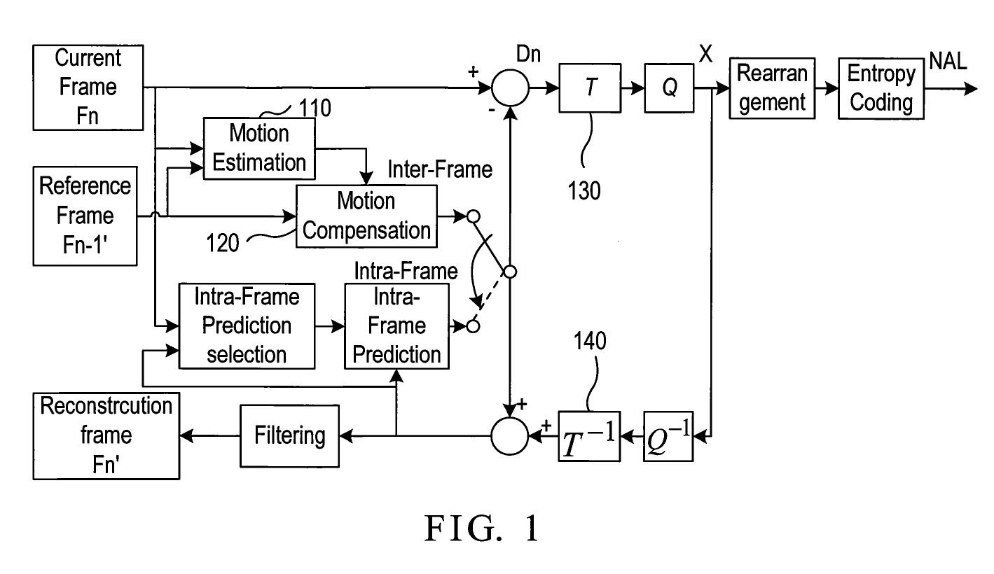

### DETAILED DESCRIPTION OF THE PREFERRED EMBODIMENT

An example of the C64+ digital signal processor (DSP) available in Texas Instruments is given for description of the invention, not for limit to the claims.

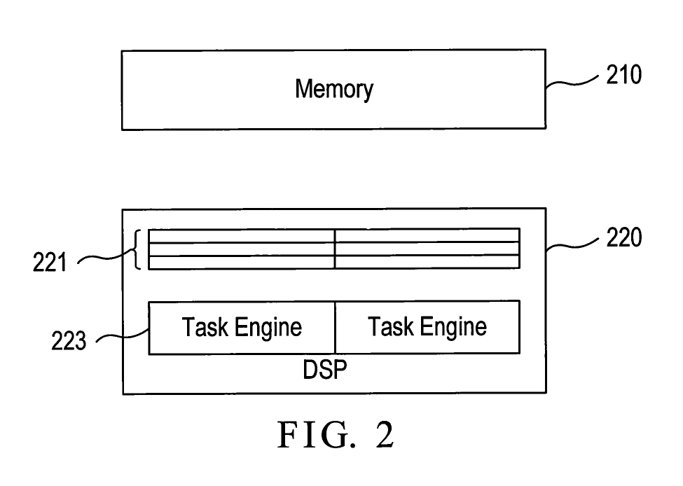

A fast integer discrete cosine transformation (DCT) method on multi-core processor is provided and used in a video compression and decompression system for performing a DCT operation on pixels of an image. FIG. 2 is a block diagram of a partial video compression and decompression system according to the invention. The system has a memory 210 and a digital signal processor (DSP) 220. The DSP 220 includes a register file 221 and two task engines 223, each having four processing units (not shown).

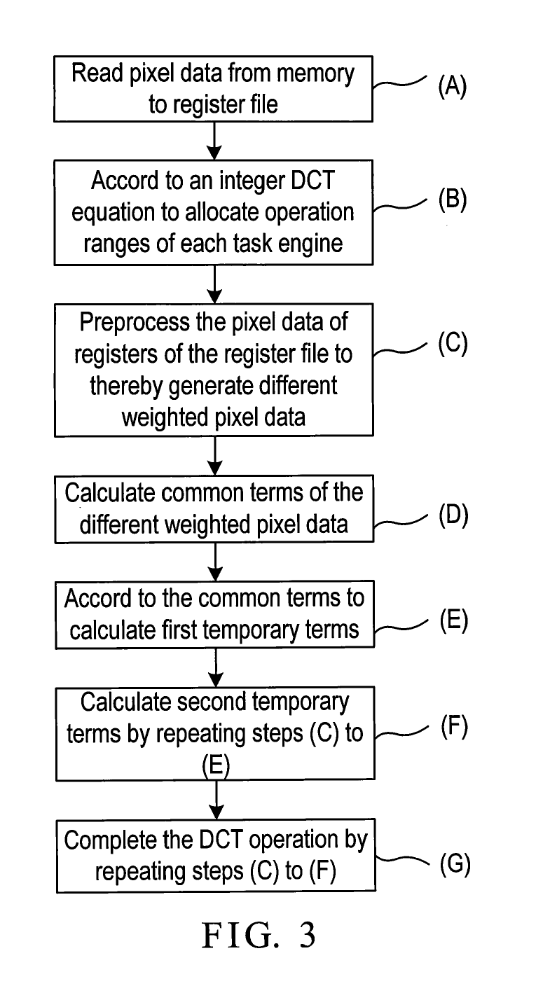

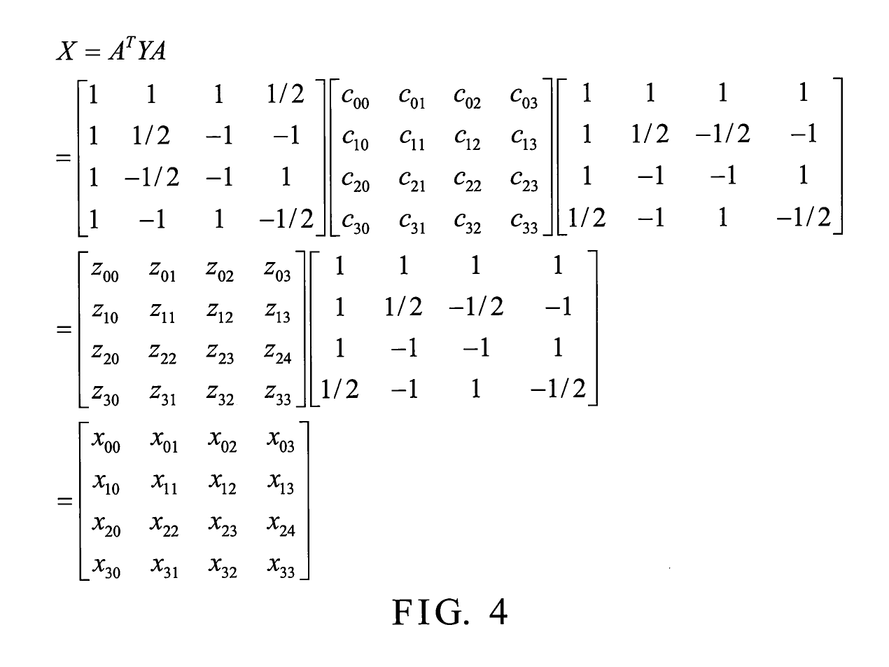

FIG. 3 is a flowchart of a fast integer discrete cosine transformation method on multi-core processor according to the invention. The method can execute an integer DCT equation efficiently to thereby obtain the result quickly. FIG. 4 is a schematic diagram of an operation of DCT matrix according to the invention. The integer DCT equation is expressed as X=A^{T}YA, where Y indicates pixel data in a 4×4 matrix with 16-bit elements, A indicates integer DCT coefficients, A^{T} indicates a transport matrix of A, and X indicates a result obtained after an integer DCT operation.

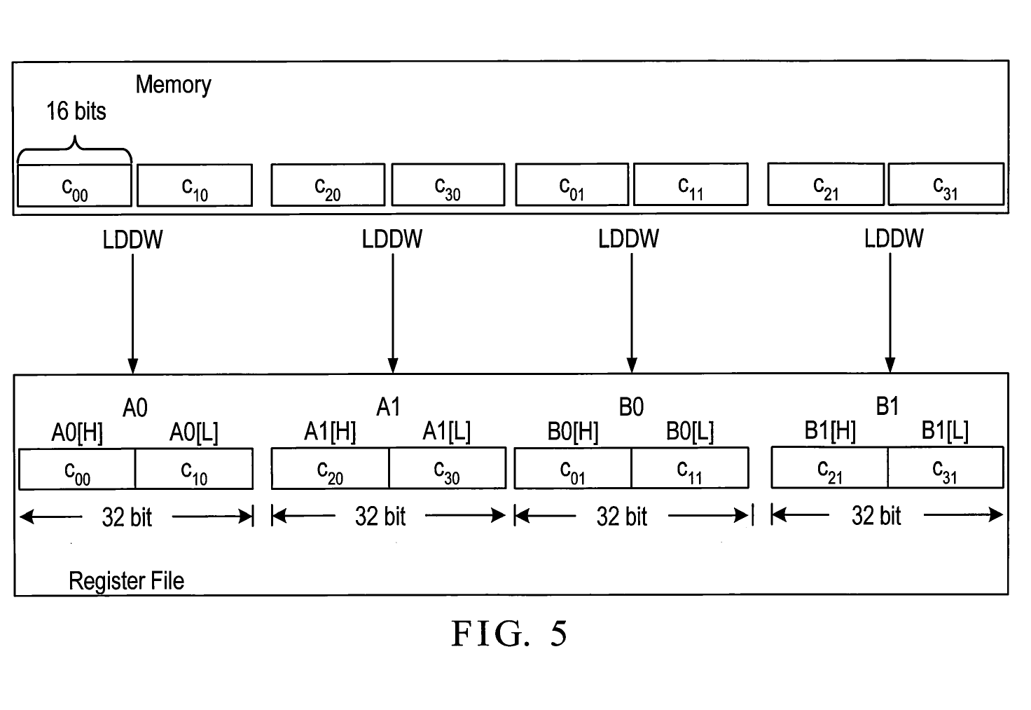

As shown in FIG. 3, step (A) reads pixel data from the memory 210 to the register file 221. Step (A) uses the LDDW instruction of the C64+ DSP to read the pixel data to the register file 221. A number of LDDW instructions to be executed are decided according to the bit number of the pixel data, the width of the data bus of the memory 210, and the bit number of the registers of the register file. An example is given in FIG. 5 where a schematic diagram of LDDW instructions for writing data in registers is shown. As shown in FIG. 5, the bit number of the pixel data is 16 bits, the data bus of the memory 210 has a width of 128 bits, and the bit number of the registers of the register file 221 is 32 bits, the LDDW instruction is executed four times to thereby write the pixel data c₀₀ to c₃₁ to the registers A0, A1, B0, B1.

Reading the data from the memory to the registers in step (A) requires filling the bandwidth to the most between the memory 210 and the registers in the fewest cycles. In addition, sending the elements to the registers requires deciding whether the space of the registers is full or not. For example, for a 16-bit pixel data, a 32-bit processor has to store two pixel data into one register.

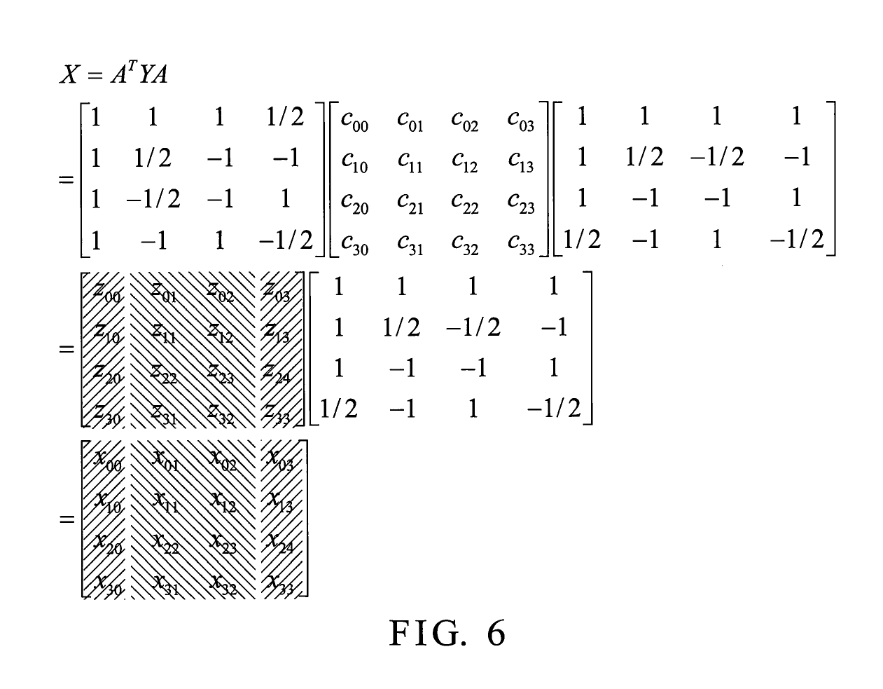

Step (B) is based on the integer DCT equation to allocate operation ranges of each task engine, which is based on a number of task engines, i.e., two task engines in this case, of the DSP to divide its operation flow into two, so as to allocate the operation ranges of each task engine. FIG. 6 is a schematic diagram of a rearranged DCT equation according to the invention. As shown in FIG. 6, the temporary result of executing A^{T}Y is expressed as a matrix Z. When the pixel data c₀₀, c₁₀, c₂₀, c₃₀ are loaded into the registers A0, A1, the first column of matrix Z can be expressed as:

$$\{ \begin{matrix}{Z}_{00} = {c}_{00} + {c}_{10} + {c}_{20} + \frac{{c}_{30}}{2} = ( {c}_{00} + {c}_{20} ) + ( {c}_{10} + \frac{{c}_{30}}{2} ) \\ {Z}_{10} = {c}_{00} + \frac{{c}_{10}}{2} - {c}_{20} - {c}_{30} = ( {c}_{00} - {c}_{20} ) + ( \frac{{c}_{10}}{2} - {c}_{30} ) \\ {Z}_{20} = {c}_{00} - \frac{{c}_{10}}{2} - {c}_{20} + {c}_{30} = ( {c}_{00} - {c}_{20} ) - ( \frac{{c}_{10}}{2} - {c}_{30} ) \\ {Z}_{30} = {c}_{00} - {c}_{10} + {c}_{20} - \frac{{c}_{30}}{2} = ( {c}_{00} + {c}_{20} ) - ( {c}_{10} + \frac{{c}_{30}}{2} ) .\end{matrix} \qquad ( 1 )$$

From equation (1), it is known that Z₀₀ and Z₃₀ are formed of two common terms (c₀₀+c₂₀) and

$$( {c}_{10} + \frac{{c}_{30}}{2} ) ,$$

and Z₀₀ and Z₃₀ are formed of another two common terms (c₀₀+c₂₀) and

$$( \frac{{c}_{10}}{2} - {c}_{30} ) .$$

Thus, the first and fourth columns of matrix Z can be processed by the first task engine, and the second and third columns can be processed by the second task engine.

Step (C) preprocesses the pixel data of the registers of the register file to thereby generate different weighted pixel data. From equation (1), since the pixel data c₀₀, c₁₀, c₂₀, c₃₀ of the common terms (c₀₀+c₂₀),

$$( {c}_{10} + \frac{{c}_{30}}{2} ) ,$$

(c₀₀−c₂₀),

$$( \frac{{c}_{10}}{2} - {c}_{30} )$$

have different weights, step (C) uses the AND instruction of the DSP to mask the desired bits and the SHR and SHVR instructions to shift bits.

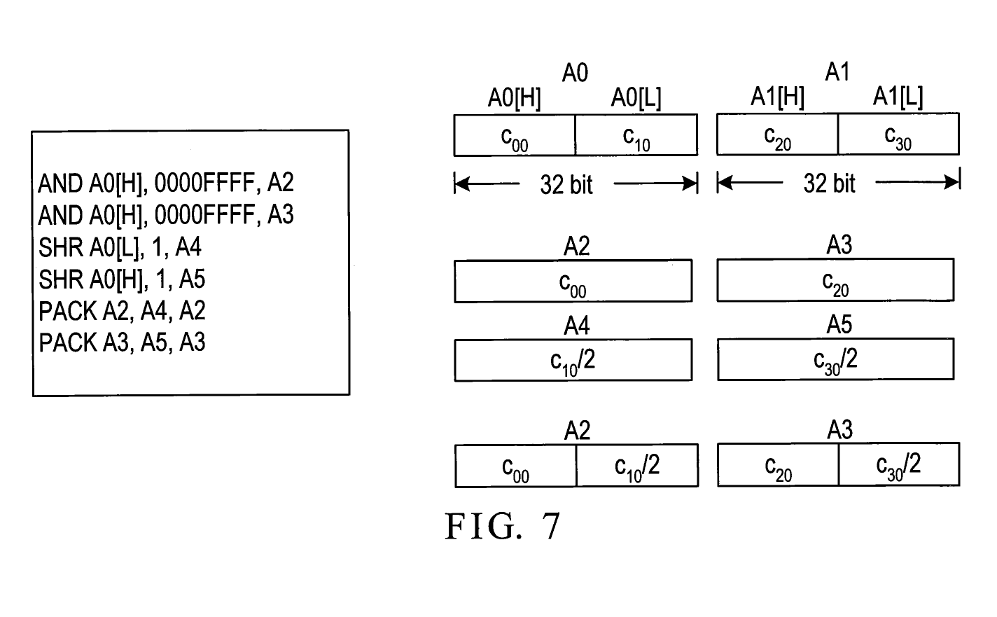

FIG. 7 is a schematic diagram of preprocessing the pixel data of the registers according to the invention. The instruction “AND A0[H], 0000FFFF, A2” is executed by extracting c₀₀ from the high word of register A0 to perform a masking operation and storing the result in register A2.

The instruction “SHR A0[L], 1, A4” is executed by extracting c₁₀ from the low word of register A0 to perform a right shifting operation by one bit and storing the result in register A4, i.e., storing

$$\frac{{c}_{10}}{2}$$

in register A4.

The instruction “PACK A2, A4, A2” is executed by combining the low words respectively of registers A2 and A4 and storing the result in register A2, i.e., storing c₀₀ in the high word of register A2 and

$$\frac{{c}_{10}}{2}$$

in the low word.

Step (D) calculates the common terms of the different weighted pixel data, which is based on the feature of a transport matrix of integer DCT coefficients to calculate the common terms (c₀₀+c₂₀),

$$( {c}_{10} + \frac{{c}_{30}}{2} ) ,$$

(c₀₀−c₂₀) and

$$( \frac{{c}_{10}}{2} - {c}_{30} ) .$$

The ADD2 and SUB2 instructions of the DSP are used to process the pixel data of the registers of the register file, and the SWAP2 instruction is used to perform a swap operation on the exchange positions respectively corresponding to two components of a register to thereby generate the common terms.

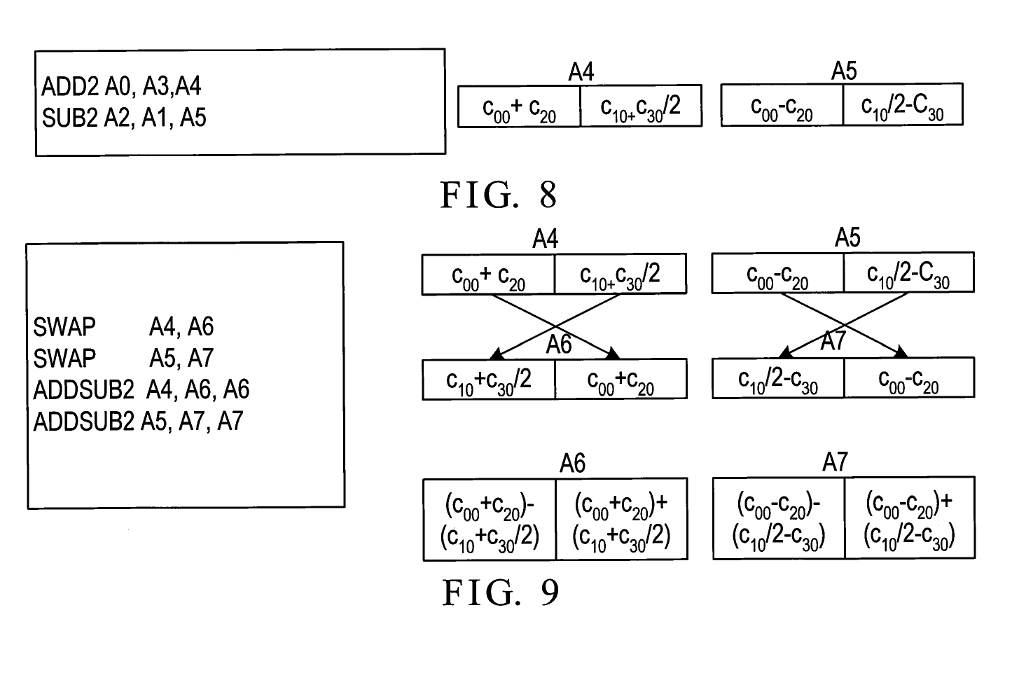

FIG. 8 is a schematic diagram of calculating the common terms according to the invention. The instruction “ADD2 A0, A3, A4” is executed by first extracting c₁₀ from the low word of register A0, extracting

$$\frac{{c}_{20}}{2}$$

from the low word of register A3, performing an addition operation and storing the result in register A4, i.e., storing

$$( {c}_{10} + \frac{{c}_{30}}{2} )$$

in the low word of register A4, and then extracting c₀₀ from the high word of register A0, extracting c₂₀ from the low word of register A3, performing an addition operation and storing the result in register A4, i.e., storing (c₀₀+c₂₀) in the high word of register A4.

Step (E) is based on the common terms to calculate the temporary terms Z₀₀, Z₁₀, Z₂₀ and Z₃₀. FIG. 9 is a schematic diagram of calculating the temporary terms according to the invention. The instruction “SWAP A4, A6” is executed by extracting

$${c}_{10} + \frac{{c}_{30}}{2}$$

from the low word of register A4 to thereby store in the high word of register A6, and extracting c₁₀+c₂₀ from the high word of register A4 to thereby store in the low word of register A6.

The instruction “ADDSUB2 A4, A6, A6” is executed by first adding the low words of registers A4 and A6 and storing the result in the low word of register A6, and then subtracting the high word of register A4 from the high word of register A6 and storing the result in the high word of register A6.

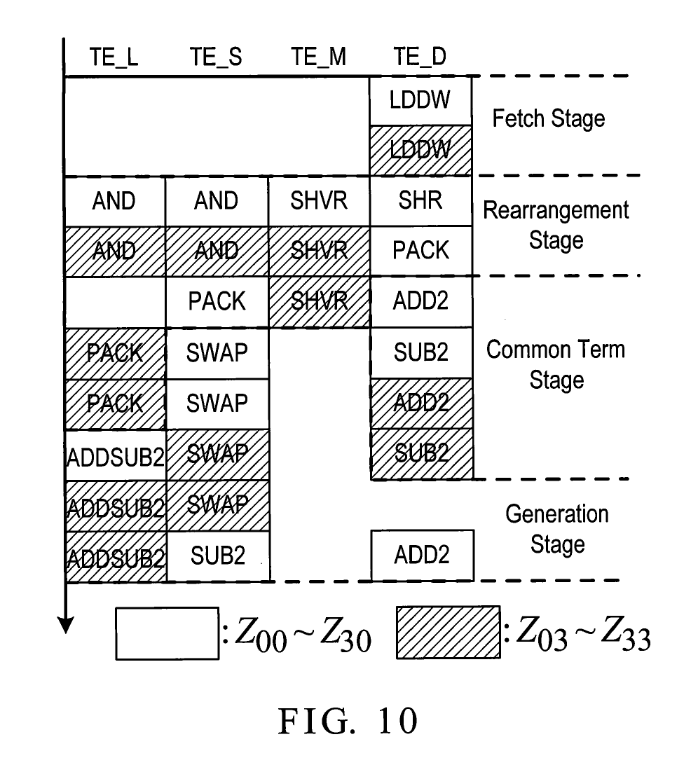

Accordingly, the temporary terms Z₀₀, Z₁₀, Z₂₀, Z₃₀ are generated in steps (A) to (E). In this case, since the DSP 220 has two task engines 223, and each task engine has four processing units TE_L, TE_S, TE_M, TE_D, the first task engine can execute steps (A) to (E) to thereby generate the temporary terms Z₀₀, Z₁₀, Z₂₀, Z₃₀, and the second task engine can also execute steps (A) to (E) to thereby generate the temporary terms Z₀₃, Z₁₃, Z₂₃, Z₃₃. FIG. 10 is a schematic diagram of an instruction allocation when the task engines work according to the invention.

Thus, step (F) calculates second temporary terms Z₀₁, Z₁₁, Z₂₁ Z₃₁, Z₀₂, Z₁₂, Z₂₂, Z₃₂ by repeating steps (C) to (E) to thereby generate find Z(=A^{T}Y).

Step (G) completes the DCT operation by repeating steps (C) to (F) to thereby generate the result X(=ZA), wherein the feature of the whole integer DCT coefficient A is used directly to calculate the common terms. As cited, steps (A) to (F) calculate a matrix product of A^{T} and Y to thereby generate the temporary terms, and step (G) calculates a matrix product of A^{T}Y and A to thereby generate the result X of a corresponding integer DCT.

In addition, the invention allocates the instructions executed by the DSP 220 in regular and symmetric. Accordingly, the common terms exhibit symmetrical arithmetical instructions. The symmetrical arithmetical instructions are properly arranged for task engines in parallel processing. The loading of the digital signal processor can be effectively reduced in performing the integer discrete cosine transformation to accordingly generate the result quickly.

Further, on developing a multimedia system, the inventive method is provided to reduce the loading of a processor in performing a DCT operation to thereby increase the performance. The method is based on the bandwidth of the register file 221 accessed by the memory 210, the utility of the processing unit of the DSP 220, and the utility of the register file 221 to gain the preferred performance and also meet the standards defined by various video compression techniques.

Furthermore, in order to effectively use the special configuration of the multi-core DSP 220 to obtain the efficient fast discrete transformation, the invention uses the special configuration and instruction set of the multi-core DSP 220 to form the fast method. The fast method uses the most accessible amount of the DSP 220 to access the data in the memory 210, and also uses the pipeline technique to smooth the data readout to the registers. In the data processing mechanism, the invention uses the multi-core implement in the configuration of the DSP 220 and the SIMD instruction set to form the fast method to enable the multi-core DSP 220 to process multiple data in a cycle. With the fast method, a block discrete transformation with 4×4 pixels can be complete in a shorter cycle. With such a high-efficient optimization, a 4CIF/CIF H.264/SVC video compression bitstream in TI DM6437 can be processed at 30 fps in very low processor loading. The method can be applied to the coding/decoding side of current multimedia systems such as H.264/AVC, H.264/SVC, H.264/MVC, AVS, and the like, while still meeting the standards defined in the digital video compression techniques. Therefore, the invention can carry out a 4×4 block DCT operation very effectively.

Although the present invention has been explained in relation to its preferred embodiment, it is to be understood that many other possible modifications and variations can be made without departing from the spirit and scope of the invention as hereinafter claimed.

What is claimed is:

1. A fast integer DCT method on multi-core processor, which is applied to a video compression and decompression system to perform an integer discrete cosine transformation (DCT) operation on pixels of an image, the system having a memory and a digital signal processor (DSP) with a register file and two task engines, the method comprising the steps of:
(A) reading pixel data from the memory to the register file;
(B) depending on an integer DCT equation to allocate operation ranges of each task engine, which is based on the number of task engines to divide its operation flow into two to accordingly allocate the operation ranges of each task engine;
(C) preprocessing the pixel data of registers of the register file to generate different weighted pixel data;
(D) calculating common terms of the different weighted pixel data, which is based on a feature of a transport matrix of integer DCT coefficients to calculate the common terms;
(E) calculating first temporary terms according to the common terms;
(F) calculating second temporary terms by repeating steps (C) to (E); and
(G) completing the DCT operation by repeating steps (C) to (F),
wherein the common terms are calculated according to a feature of the integer DCT coefficients.

2. The method as claimed in claim 1, wherein the integer DCT equation is expressed as X=A^{T}YA, where Y indicates pixel data, A indicates integer DCT coefficients, A^{T} indicates a transport matrix of A, and X indicates a result obtained after an integer DCT operation.

3. The method as claimed in claim 2, wherein steps (A) to (F) calculate a matrix product of A^{T} and Y to thereby generate the second temporary terms, and step (G) calculates a matrix product of A^{T}Y and A to thereby generate the result X.

4. The method as claimed in claim 3, wherein step (A) uses a load instruction of the DSP to read the pixel data from the memory to the register file.

5. The method as claimed in claim 4, wherein step (C) uses an AND instruction of the DSP to mask desired bits, and uses SHR and SHVR instructions to shift bits.

6. The method as claimed in claim 5, wherein step (D) uses ADD2 and SUB2 instructions of the DSP to process the pixel data of the registers of the register file, and a SWAP2 instruction to perform a swap operation on exchange positions respectively corresponding to two components of a register to thereby generate the common terms.

7. The method as claimed in claim 6, wherein the number of load instruction to be executed in step (A) is based on a bit number of the pixel data, a width of data bus of the memory, and a bit number of the registers of the register file.

8. The method as claimed in claim 7, wherein the pixel data Y is in a 4×4 matrix with 16-bit elements.

9. The method as claimed in claim 8, wherein the DSP is a TI C64 processor.

10. The method as claimed in claim 9, wherein each task engine has four processing units.
